(19) United States
(12) Patent Application Publication
(10) Pub. No.: US 2018/0264600 A1
(43) Pub. Date: Sep. 20, 2018

(54) MEASURING APPARATUS AND LASER WELDING APPARATUS

(71) Applicant: Toyota Jidosha Kabushiki Kaisha, Toyota-shi Aichi-ken (JP)

(72) Inventor: Hiroki Sugino, Toyota-shi Aichi-ken (JP)

(73) Assignee: Toyota Jidosha Kabushiki Kaisha, Toyota-shi Aichi-ken (JP)

(21) Appl. No.: 15/915,576

(22) Filed: Mar. 8, 2018

(30) Foreign Application Priority Data
Mar. 17, 2017 (JP) 2017-052957

(51) Int. Cl. B23K 31/12; B23K 26/21; B23K 26/03; B23K 26/082

(52) U.S. Cl. CPC B23K 31/125; B23K 26/082; B23K 26/03; B23K 26/21

(57) ABSTRACT

A laser welding apparatus includes a measuring unit that measures a penetration depth of a molten pool by interferometry, and a controller that controls the measuring unit. The measuring unit includes a light source emitting a laser beam for measurement, a splitter that splits the laser beam into a measuring beam and a reference beam, a light-receiving element receiving an interference beam synthesized from the measuring beam reflected from the molten pool and the reference beam reflected from the reference mirror, a scanning mechanism that varies an application position of the measuring beam travelling toward the molten pool, and an image-capturing unit that captures an image of the molten pool. The controller determines a deepest portion of the molten pool based on the image captured by the image-capturing unit, and controls the scanning mechanism such that the measuring beam travelling toward the molten pool is applied to the deepest portion.

### CROSS-REFERENCE TO RELATED APPLICATIONS

This application claims priority to Japanese Patent Application No. 2017-052957 filed on Mar. 17, 2017, which is incorporated herein by reference in its entirety including the specification, drawings and abstract.

### BACKGROUND

### 1. Technical Field

The disclosure relates to a measuring apparatus and a laser welding apparatus.

### 2. Description of Related Art

There is a laser welding apparatus configured to perform welding by applying a laser beam to a workpiece (see, for example, Japanese Unexamined Patent Application Publication No. 2012-236196 (JP 2012-236196 A)).

The laser welding apparatus described in JP 2012-236196 A includes a laser oscillator configured to emit a laser beam for welding, and an optical interferometer configured to measure a penetration depth of a weld portion of a workpiece. The laser welding apparatus is configured to evaluate the quality of the weld portion based on the penetration depth. An object beam emitted from the optical interferometer is coaxially superimposed on a laser beam from the laser oscillator and then applied to the weld portion. The spot diameter of the object beam is set to be larger than the spot diameter of the laser beam. Thus, the object beam is applied to a keyhole of a molten pool that is formed during laser welding, and the depth of the keyhole can be measured as the penetration depth.

### SUMMARY

However, with the conventional laser welding apparatus described above, the spot diameter of the object beam is large and thus the depth is detected in a wide region. It is therefore difficult to improve the accuracy of measurement of a penetration depth.

The disclosure provides a measuring apparatus and a laser welding apparatus that are configured to measure, with a higher degree of accuracy, a penetration depth of a molten pool of a workpiece during laser welding.

A first aspect of the disclosure relates to a measuring apparatus configured to measure a penetration depth of a molten pool of a workpiece during laser welding. The measuring apparatus includes: a measuring unit configured to measure the penetration depth of the molten pool by interferometry; and a controller configured to control the measuring unit. The measuring unit includes: a light source configured to emit a laser beam for measurement; a splitter configured to split the laser beam for measurement into a measuring beam travelling toward the molten pool and a reference beam travelling toward a reference mirror; a light-receiving element configured such that an interference beam is incident on the light-receiving element; a scanning mechanism configured to vary an application position of the measuring beam travelling toward the molten pool; and an image-capturing unit configured to capture an image of the molten pool. The interference beam is synthesized from the measuring beam reflected from the molten pool and the reference beam reflected from the reference mirror. The controller is configured to i) determine a deepest portion of the molten pool based on a result of image capturing performed by the image-capturing unit, and ii) control the scanning mechanism such that the measuring beam travelling toward the molten pool is applied to the deepest portion.

This configuration allows the measuring beam to be applied to the deepest portion of the molten pool, so that the measuring beam is suppressed from being applied to the region of the molten pool other than the deepest portion. It is thus possible to improve the accuracy of measurement of the penetration depth of the molten pool.

A second aspect of the disclosure relates to a laser welding apparatus including: a laser welding unit including a first light source configured to emit a laser beam for welding, and a first scanning mechanism configured to vary an application position of the laser beam for welding; a measuring unit configured to measure a penetration depth of a molten pool of a workpiece during laser welding by interferometry; and a controller configured to control the laser welding unit and the measuring unit. The measuring unit includes: a second light source configured to emit a laser beam for measurement; a splitter configured to split the laser beam for measurement into a measuring beam travelling toward the molten pool and a reference beam travelling toward a reference mirror; a light-receiving element configured such that an interference beam is incident on the light-receiving element; a second scanning mechanism configured to vary an application position of the measuring beam travelling toward the molten pool; and an image-capturing unit configured to capture an image of the molten pool. The interference beam is synthesized from the measuring beam reflected from the molten pool and the reference beam reflected from the reference mirror. The controller is configured to i) determine a deepest portion of the molten pool based on a result of image capturing performed by the image-capturing unit, ii) control the second scanning mechanism such that the measuring beam travelling toward the molten pool is applied to the deepest portion, and measure a penetration depth of the deepest portion, and iii) control a power of the first light source based on the penetration depth of the deepest portion.

This configuration allows the measuring beam to be applied to the deepest portion of the molten pool, so that the measuring beam is suppressed from being applied to the region of the molten pool other than the deepest portion. It is thus possible to improve the accuracy of measurement of the penetration depth of the molten pool. In addition, controlling the power of the first light source based on the penetration depth of the deepest portion allows the penetration depth to be appropriately adjusted during laser welding. It is thus possible to reduce the occurrence of poor joining.

The measuring apparatus and the laser welding apparatus according to the disclosure improve the accuracy of measurement of a penetration depth of a molten pool of a workpiece during laser welding.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a diagram schematically illustrating a laser welding apparatus according to a first embodiment;

FIG. 2 is a block diagram illustrating the laser welding apparatus in FIG. 1;

FIG. 3 is a sectional view schematically illustrating a molten pool of a workpiece during laser welding;

FIG. 4 is a plan view schematically illustrating the molten pool of the workpiece during laser welding;

FIG. 5 is a flowchart illustrating an operation of the laser welding apparatus according to the first embodiment; and

FIG. 6 is a flowchart illustrating an operation of a laser welding apparatus according to a second embodiment.

### DETAILED DESCRIPTION OF EMBODIMENTS

Hereafter, example embodiments of the disclosure will be described with reference to the accompanying drawings.

### First Embodiment

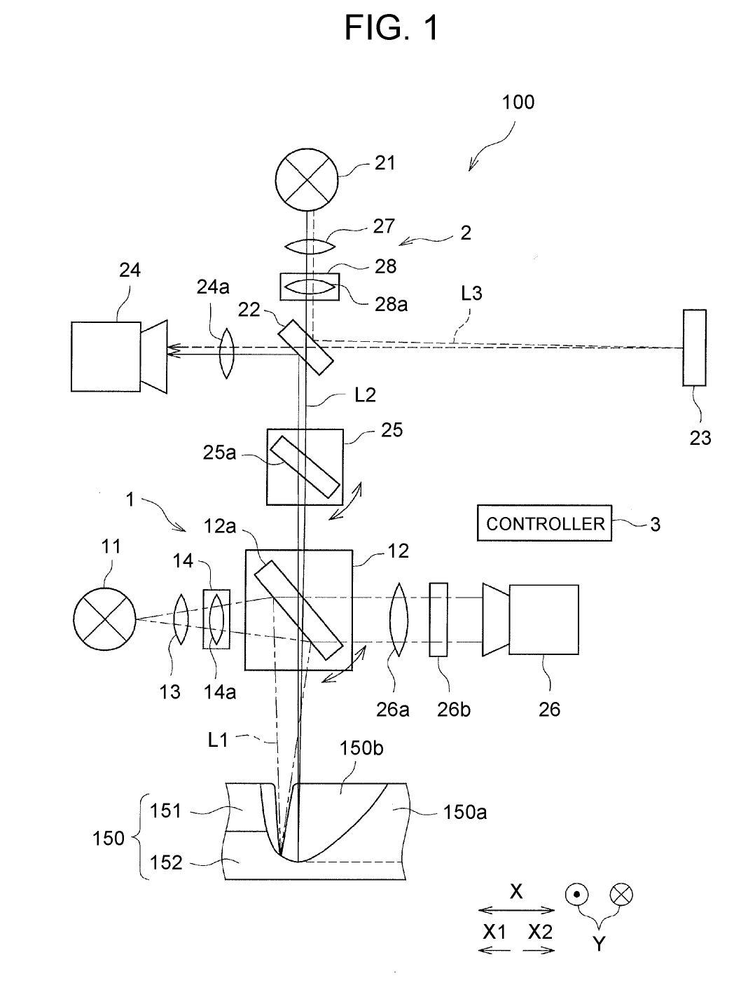

First, with reference to FIG. 1 to FIG. 4, a laser welding apparatus 100 according to a first embodiment of the disclosure will be schematically described.

As illustrated in FIG. 1, the laser welding apparatus 100 is configured to perform welding by applying a laser beam L1 to, for example, a workpiece 150 including two steel plates 151, 152. Further, the laser welding apparatus 100 is configured to measure a penetration depth of a molten pool 150b of the workpiece 150 during laser welding. The laser welding apparatus 100 includes a laser welding unit 1, a measuring unit 2, and a controller 3.

The laser welding unit 1 is provided in order to perform laser welding on the workpiece 150 (i.e., to weld the steel plates 151, 152 to each other). The laser welding unit 1 includes a laser oscillator 11, a scanning mechanism 12, a collimator 13, and a focusing mechanism 14.

The laser oscillator 11 is configured to emit the laser beam L1 for welding. For example, the power of the laser oscillator 11 during emission of the laser beam L1 is set based on, for example, the material of the workpiece 150 such that the steel plates 151, 152 of the workpiece 150 can be welded to each other. Note that the laser oscillator 11 is an example of “first light source” in the disclosure.

The scanning mechanism 12 is provided in order to vary a position to which the laser beam L1 is applied (hereinafter, referred to as “application position of the laser beam L1”) with respect to the workpiece 150. The scanning mechanism 12 includes a pair of galvanometer mirrors 12a. Each of the galvanometer mirrors 12a is pivotably provided. Note that, for the sake of convenience, FIG. 1 illustrates only the galvanometer mirror 12a configured to vary the application position of the laser beam L1 in an X-direction with respect to the workpiece 150, and does not illustrate the galvanometer mirror 12a configured to vary the application position of the laser beam L1 in a Y-direction (i.e., in a direction perpendicular to the sheet on which FIG. 1 is drawn) with respect to the workpiece 150. The application position of the laser beam L1 can be varied by adjusting the angles of the two galvanometer mirrors 12a of the scanning mechanism 12. In addition, the scanning mechanism 12 is configured to vary a position to which a measuring beam L2 (described later) is applied (hereinafter, referred to as “application position of the measuring beam L2”) and to vary an imaging range for the image-capturing unit 26 (described later). Note that the scanning mechanism 12 is an example of “first scanning mechanism” according to the disclosure.

The collimator 13 is disposed between the laser oscillator 11 and the focusing mechanism 14. The collimator 13 is provided in order to collimate the laser beam L1 emitted from the laser oscillator 11. The focusing mechanism 14 is disposed between the collimator 13 and the scanning mechanism 12. The focusing mechanism 14 includes a lens 14a that is movable in a direction of the optical axis of the laser beam L1. The focusing mechanism 14 is configured to adjust a position of the lens 14a, thereby adjusting a focal distance of the laser beam L1.

The measuring unit 2 is provided in order to measure a penetration depth of the molten pool 150b of the workpiece 150 by interferometry. The measuring unit 2 includes a swept light source 21, a beam splitter 22, a reference mirror 23, a light-receiving element 24, a scanning mechanism 25, an image-capturing unit 26, a collimator 27, and a focusing mechanism 28.

The swept light source 21 is configured to emit a laser beam for measurement. The swept light source 21 is configured to temporally vary a wavelength of the laser beam to be emitted and used for measurement. Note that the swept light source 21 is an example of each of “light source” and “second light source” according to the disclosure.

The beam splitter 22 is configured to split the laser beam emitted from the swept light source 21 and used for measurement, into a measuring beam L2 travelling toward the molten pool 150b of the workpiece 150 and a reference beam L3 travelling toward the reference mirror 23. Note that the beam splitter 22 is an example of “splitter” according to the disclosure.

The reference mirror 23 is provided in order to reflect the reference beam L3 from the beam splitter 22 and send the reference beam L3 to the light-receiving element 24.

The measuring beam L2 passes through the scanning mechanisms 25, 12 to be applied to the molten pool 150b of the workpiece 150. The measuring beam L2 reflected from a bottom portion of the molten pool 150b passes through the scanning mechanisms 12, 25 to be sent to the light-receiving element 24. The light-receiving element 24 is configured such that an interference beam synthesized from the measuring beam L2 reflected from the bottom portion of the molten pool 150b and the reference beam L3 reflected from the reference mirror 23 is incident on the light-receiving element 24. The interference beam corresponding to a difference in optical path length between the measuring beam L2 and the reference beam L3 is incident on the light-receiving element 24. Thus, the penetration depth of the molten pool 150b can be measured based on the interference beam. A lens 24a that focuses the interference beam on the light-receiving element 24 is provided between the light-receiving element 24 and the beam splitter 22.

The scanning mechanism 25 is disposed between the beam splitter 22 and the scanning mechanism 12. The scanning mechanism 25 is provided in order to correct the application position of the measuring beam L2. Specifically, the scanning mechanism 25 is configured to adjust the application position of the measuring beam L2 with respect to the application position of the laser beam L1, which is varied by the scanning mechanism 12. The scanning mechanism 25 includes a pair of galvanometer mirrors 25a. Each of the galvanometer mirrors 25a is pivotably provided. Note that, for the sake of convenience, FIG. 1 illustrates only the galvanometer mirror 25a configured to vary the application position of the measuring beam L2 in the X-direction with respect to the workpiece 150, and does not illustrate the galvanometer mirror 25a configured to vary the application position of the measuring beam L2 in the Y-direction with respect to the workpiece 150. The application position of the measuring beam L2 can be varied by adjusting the angles of the two galvanometer mirrors 25a of the scanning mechanism 25. Note that the scanning mechanism 25 is an example of each of “scanning mechanism” and “second scanning mechanism” according to the disclosure.

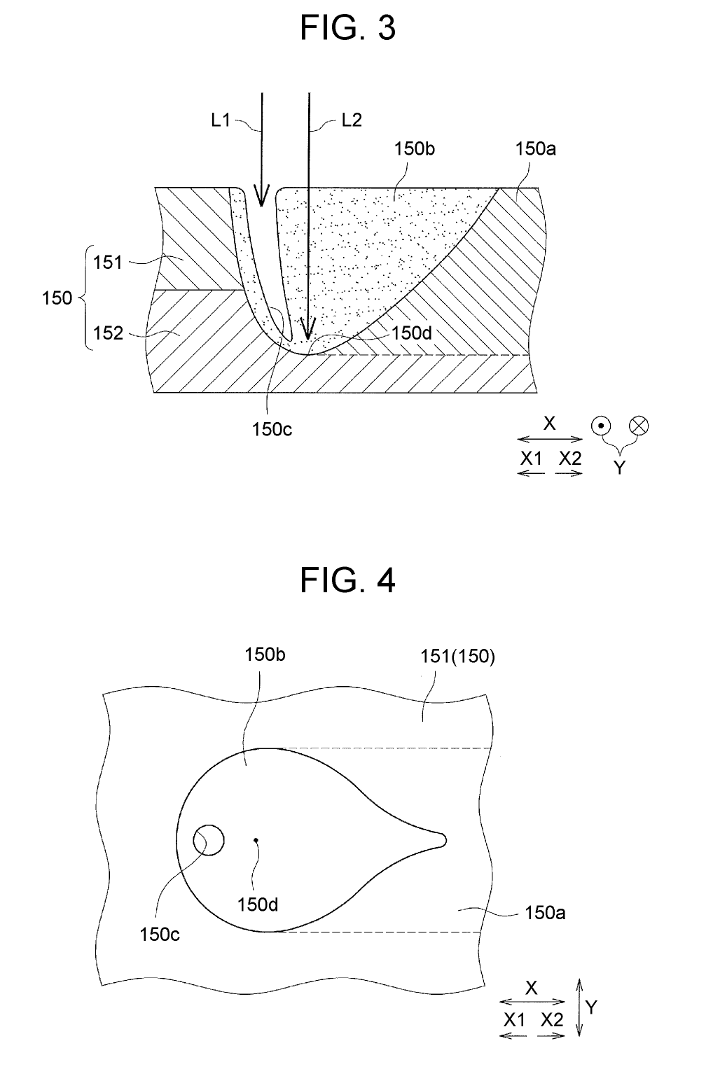

The image-capturing unit 26 has a function of capturing an image of the molten pool 150b of the workpiece 150 during laser welding. The image-capturing unit 26 is provided in order to determine a deepest portion 150d, which is the deepest portion of the molten pool 150b (see FIG. 3 and FIG. 4). The image-capturing unit 26 is an area sensor, such as a charge-coupled device (CCD) image sensor or a complementary metal oxide semiconductor (CMOS) image sensor. The image-capturing unit 26 is configured to capture an image of an area around the optical axis of the laser beam L1 travelling from the scanning mechanism 12 toward the workpiece 150. Specifically, the image-capturing unit 26 is provided so as to capture an image of the molten pool 150b through the scanning mechanism 12. Thus, the imaging range is varied as the scanning mechanism 12 varies the application position of the laser beam L1. A lens 26a that focuses the beam from the workpiece 150 on the image-capturing unit 26 and a filter 26b that removes beams in an unnecessary band are provided between the image-capturing unit 26 and the scanning mechanism 12.

The collimator 27 is disposed between the swept light source 21 and the focusing mechanism 28. The collimator 27 is provided in order to collimate the laser beam emitted from the swept light source 21. The focusing mechanism 28 is disposed between the collimator 27 and the beam splitter 22. The focusing mechanism 28 includes a lens 28a that is movable in a direction of the optical axis of the laser beam from the swept light source 21. The focusing mechanism 28 is configured to adjust a position of the lens 28a, thereby adjusting a focal distance of the measuring beam L2.

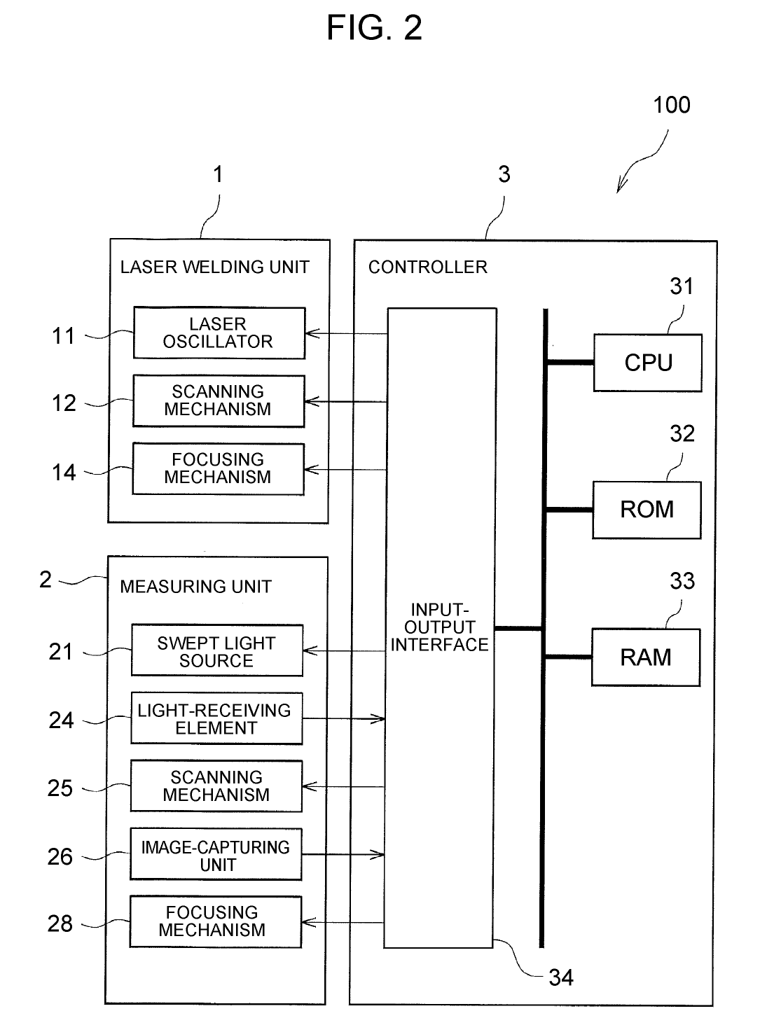

The controller 3 is configured to control the laser welding apparatus 100, as illustrated in FIG. 2. The controller 3 includes a central processing unit (CPU) 31, a read-only memory (ROM) 32, a random-access memory (RAM) 33, and an input-output interface 34. Note that the controller 3 is an example of “controller” according to the disclosure.

The CPU 31 is configured to execute calculation processes based on, for example, programs and data stored in the ROM 32. The ROM 32 stores, for example, programs and data used for control. The RAM 33 is provided in order to temporarily store, for example, results of calculation executed by the CPU 31. The laser welding unit 1 and the measuring unit 2 are connected to the input-output interface 34.

The controller 3 is configured to control the laser welding unit 1 to perform welding on the workpiece 150, and configured to control the measuring unit 2 to measure a penetration depth of the molten pool 150b of the workpiece 150. The measuring unit 2 and the controller 3 constitute “measuring apparatus” according to the disclosure.

Next, a phenomenon that occurs during laser welding will be described. With reference to FIG. 3 and FIG. 4, a case where the application position of the laser beam L1 for welding is varied in an X1-direction will be described below.

First, as illustrated in FIG. 3, when the laser beam L1 for welding is applied to the workpiece 150, the workpiece 150 is partially melted to form the molten pool 150b. At this time, the workpiece 150 is partially vaporized due to application of the laser beam L1, and a reaction force of metal vapor generates a recess that develops into a keyhole 150c. The application position of the laser beam L1 is then varied in the X1-direction. When the molten metal is solidified, a weld portion (weld bead) 150a is formed. The depth of the weld portion 150a is correlated with a joining strength, and the depth of the deepest portion of the weld portion 150a is equal to the depth of the deepest portion 150d of the molten pool 150b.

When the application position of the laser beam L1 is varied in the X1-direction as described above, the deepest portion 150d of the molten pool 150b is offset in an X2-direction (a direction opposite to the X1-direction) from a position where the keyhole 150c is formed due to application of the laser beam L1, as illustrated in FIG. 3 and FIG. 4. Thus, if the measuring beam L2 for measurement of the penetration depth of the molten pool 150b is applied coaxially with the laser beam L1, the depth of a portion that is shallower than the deepest portion 150d is detected, and therefore the penetration depth of the molten pool 150b cannot be measured appropriately. If a focus diameter of the measuring beam L2 is increased so as to cover the deepest portion 150d, the depth is detected in a wide region. It is therefore difficult to measure the penetration depth of the molten pool 150b with a high degree of accuracy. An amount by which the deepest portion 150d is offset from the laser beam L1 varies depending on the power of the laser oscillator 11 during emission of the laser beam L1, the scanning speed, the material of the workpiece 150, and so forth.

In view of this, in the first embodiment, the controller 3 is configured to determine the deepest portion 150d of the molten pool 150b based on the result of image capturing performed by the image-capturing unit 26, and to control the scanning mechanism 25 such that the measuring beam L2 travelling toward the molten pool 150b is applied to the deepest portion 150d. Note that the controller 3 is capable of determining the deepest portion 150d of the molten pool 150b based on the light and dark in an image captured by the image-capturing unit 26.

Operation During Laser Welding

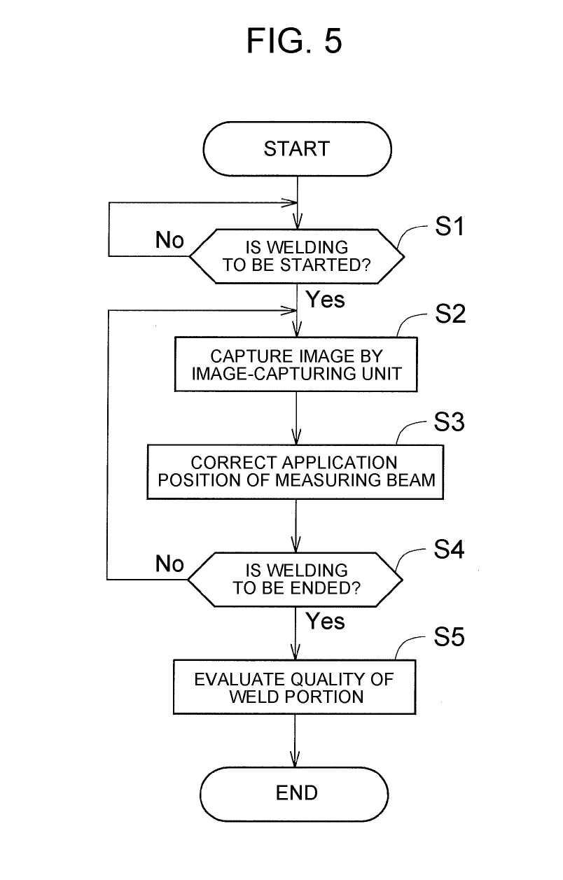

Next, an operation of the laser welding apparatus 100 according to the first embodiment will be described with reference to FIG. 5. The controller 3 executes the following steps.

First, the controller 3 determines in step S1 in FIG. 5 whether welding is to be started. When the controller 3 determines that welding is to be started, welding is started and the controller 3 proceeds to step S2. On the other hand, when the controller 3 determines that welding is not to be started, step S1 is repeatedly executed. That is, the laser welding apparatus 100 is kept in a stand-by mode until welding is started.

When welding is started, a laser beam L1 for welding is emitted from the laser oscillator 11. The laser beam L1 is applied to the workpiece 150 through the collimator 13, the focusing mechanism 14, and the scanning mechanism 12. The laser beam L1 emitted from the laser oscillator 11 is controlled by the controller 3. As the controller 3 controls the focusing mechanism 14, the focal distance of the laser beam L1 is adjusted. As the controller 3 controls the scanning mechanism 12, the application position of the laser beam L1 is varied with respect to the workpiece 150. The focal distance and the beam application path are set based on, for example, teaching data stored in advance.

When welding is started, measurement of a penetration depth of the molten pool 150b of the workpiece 150 during laser welding is started. Specifically, a laser beam for measurement is emitted from the swept light source 21. The laser beam for measurement is incident on the beam splitter 22 through the collimator 27 and the focusing mechanism 28, and is then split into a measuring beam L2 and a reference beam L3 by the beam splitter 22. The laser beam emitted from the swept light source 21 is controlled by the controller 3. As the controller 3 controls the focusing mechanism 28, the focal distance of the measuring beam L2 is adjusted. The focal distance is set based on, for example, teaching data stored in advance.

The measuring beam L2 is then applied to the molten pool 150b of the workpiece 150 through the scanning mechanisms 25, 12. The measuring beam L2 is reflected from the bottom portion of the molten pool 150b to be returned to the beam splitter 22 through the scanning mechanisms 12, 25. On the other hand, the reference beam L3 is reflected from the reference mirror 23 to be returned to the beam splitter 22. Then, an interference beam synthesized from the measuring beam L2 reflected from the bottom portion of the molten pool 150b and the reference beam L3 reflected from the reference mirror 23 is incident on the light-receiving element 24. Based on the interference beam incident on the light-receiving element 24, the controller 3 measures a penetration depth of the molten pool 150b.

Next, the image-capturing unit 26 captures an image in step S2. Thus, an image of the molten pool 150b of the workpiece 150 is captured. As the scanning mechanism 12 varies the application position of the laser beam L1, an imaging range for the image-capturing unit 26 is varied by the scanning mechanism 12. That is, the scanning mechanism 12 can coaxially vary the optical axis of the laser beam L1 with respect to the workpiece 150 and a capturing axis of the image-capturing unit 26. Based on the result of image capturing performed by the image-capturing unit 26, the controller 3 determines the deepest portion 150d of the molten pool 150b.

Then, the controller 3 controls the scanning mechanism 25, thereby correcting the application position of the measuring beam L2 in step S3. Specifically, the scanning mechanism 25 is controlled such that the measuring beam L2 is applied to the deepest portion 150d of the molten pool 150b. If the application position of the measuring beam L2 is not corrected by the scanning mechanism 25, the optical axis of the measuring beam L2 travelling from the scanning mechanism 12 toward the workpiece 150 coincides with the optical axis of the laser beam L1 travelling from the scanning mechanism 12 toward the workpiece 150. Therefore, the scanning mechanism 25 corrects the application position of the measuring beam L2 by an amount by which the deepest portion 150d is offset from the laser beam L1. Thus, the measuring beam L2 is appropriately applied to the deepest portion 150d of the molten pool 150b, without the need to increase the focus diameter of the measuring beam L2. It is therefore possible to measure a penetration depth of the molten pool 150b with a high degree of accuracy.

Next, the controller 3 determines in step S4 whether welding is to be ended. When the controller 3 determines that welding is not to be ended, the controller 3 returns to step S2. On the other hand, when the controller 3 determines that welding is to be ended, the controller 3 proceeds to step S5.

Next, the controller 3 evaluates the quality of the weld portion 150a in step S5. The controller 3 determines, for example, whether the penetration depth of the molten pool 150b measured during laser welding is within a prescribed range. The prescribed range is used to determine whether the penetration depth is appropriate. The prescribed range is set in advance based on, for example, a required joining strength. When the penetration depth is within the prescribed range, the controller 3 determines that the weld portion 150a is in a satisfactory joining state, whereas when the penetration depth is out of the prescribed range, the controller 3 determines that the weld portion 150a is in a poor joining state. Then, the controller 3 ends the routine.

### Advantageous Effect

In the first embodiment, as described above, the deepest portion 150c1 of the molten pool 150b is determined based on the result of image capturing performed by the image-capturing unit 26, and the scanning mechanism 25 is controlled such that the measuring beam L2 is applied to the deepest portion 150d. This control allows the measuring beam L2 to be applied to the deepest portion 150d of the molten pool 150b, so that the measuring beam L2 is suppressed from being applied to the region of the molten pool 150b other than the deepest portion 150d. It is thus possible to improve the accuracy of measurement of the penetration depth of the molten pool 150b. As a result, it is possible to improve the accuracy of evaluation of the quality of the weld portion 150a of the workpiece 150.

### Second Embodiment

Next, a laser welding apparatus according to a second embodiment of the disclosure will be described. The configuration of the second embodiment is substantially the same as that of the first embodiment described above. Therefore, the same reference symbols as those in the first embodiment will be used in the following description.

The laser welding apparatus according to the second embodiment is configured to i) determine the deepest portion 150d of the molten pool 150b based on the result of image capturing performed by the image-capturing unit 26, ii) control the scanning mechanism 25 such that the measuring beam L2 travelling toward the molten pool 150b is applied to the deepest portion 150d and measure the penetration depth of the deepest portion 150d, and iii) control the power of the laser oscillator 11 based on the penetration depth of the deepest portion 150d.

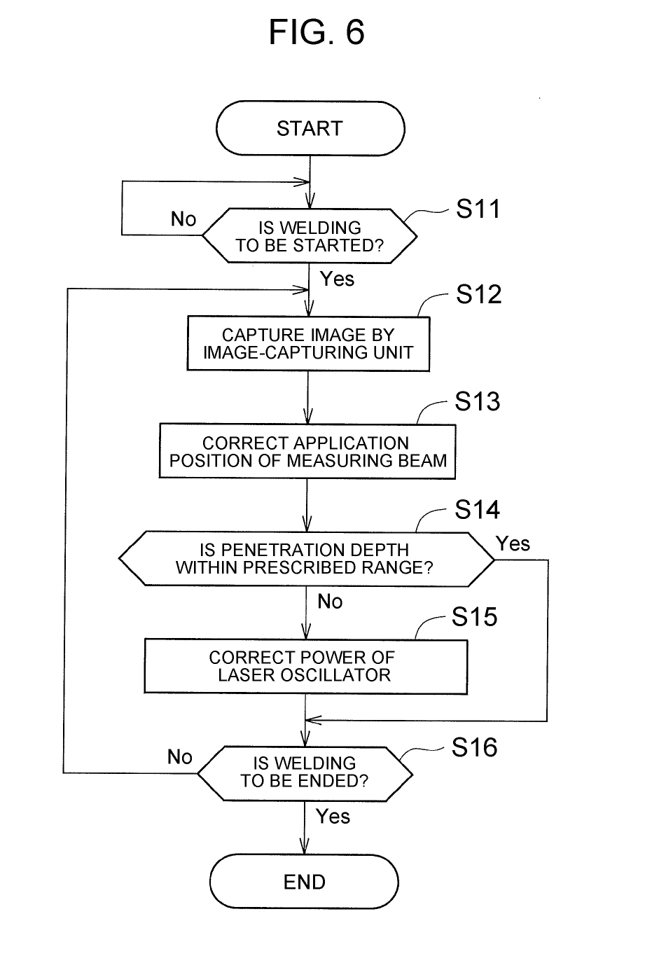

Next, an operation of the laser welding apparatus according to the second embodiment will be described with reference to FIG. 6. The controller 3 executes the following steps.

Steps S11 to S13 in FIG. 6 are the same as step S1 to S3 described above, and therefore will not be described below.

Next, the controller 3 determines in step S14 whether the penetration depth of the molten pool 150b is within a prescribed range. The prescribed range is used to determine whether the penetration depth is appropriate. The prescribed range is set in advance based on, for example, a required joining strength. When the controller 3 determines that the penetration depth is within the prescribed range, the controller 3 proceeds to step S16 because the penetration depth is appropriate. On the other hand, when the controller 3 determines that the penetration depth is not within the prescribed range (i.e., the penetration depth is out of the prescribed range), the controller 3 proceeds to step S15 because the penetration depth is not appropriate.

Next, the power of the laser oscillator 11 that emits the laser beam L1 for welding is corrected. For example, when the penetration depth is less than a lower-limit of the prescribed range, the power of the laser oscillator 11 is corrected to be increased, whereas when the penetration depth is greater than an upper-limit of the prescribed range, the power of the laser oscillator 11 is corrected to be decreased. Note that an amount of correction of the power may be set based on an amount by which the penetration depth is deviated from the upper-limit or the lower limit of the prescribed range of the penetration depth, or may be a fixed value set in advance. Then, the controller 3 proceeds to step S16.

Next, the controller 3 determines in step S16 whether welding is to be ended. When the controller 3 determines that welding is not to be ended, the controller 3 returns to step S12. On the other hand, when the controller 3 determines that welding is to be ended, the controller 3 ends the routine.

### Advantageous Effect

In the second embodiment, as described above, the deepest portion 150d of the molten pool 150b is determined based on the result of image capturing performed by the image-capturing unit 26, and the scanning mechanism 25 is controlled such that the measuring beam L2 is applied to the deepest portion 150d. This control allows the measuring beam L2 to be applied to the deepest portion 150d of the molten pool 150b, so that the measuring beam L2 is suppressed from being applied to the region of the molten pool 150b other than the deepest portion 150d. It is thus possible to improve the accuracy of measurement of the penetration depth of the molten pool 150b. In addition, controlling the power of the laser oscillator 11 based on the penetration depth of the deepest portion 150d allows the penetration depth to be appropriately adjusted during laser welding. It is thus possible to reduce the occurrence of poor joining.

### OTHER EMBODIMENTS

Note that the embodiments that have been disclosed in the specification are to be considered in all respects as illustrative and not restrictive. The technical scope is defined by claims instead of being defined only by the embodiments, and all changes which come within the meaning and range of equivalency of the claims are therefore intended to be embraced therein.

For example, in the first and the second embodiments, the workpiece 150 including the two steel plates 151, 152 is described. However, a workpiece is not limited to the workpiece 150, and a workpiece including three or more steel plates may be used. A workpiece including members other than steel plates may be used.

In the first and second embodiments, an example in which the application position of the laser beam L1 for welding is varied in the X1-direction is described. However, this example does not limit the scope of the disclosure, and the application path may be in another shape, such as a round shape.

In the first and second embodiments, an example in which the application position of the laser beam L1 for welding is varied by the scanning mechanism 12 is described. However, this example does not limit the scope of the disclosure, and the application position of the laser beam for welding may be varied by a stage (not illustrated) to which the workpiece is fixed.

In the first embodiment, an example in which the quality of the weld portion is evaluated after welding ends is described. However, this example does not limit the scope of the disclosure, and the quality of the weld portion may be evaluated during welding.

The disclosure is applicable to a measuring apparatus configured to measure a penetration depth of a molten pool of a workpiece during laser welding, and is applicable also to a laser welding apparatus including the measuring apparatus.

What is claimed is:

1. A measuring apparatus configured to measure a penetration depth of a molten pool of a workpiece during laser welding, the measuring apparatus comprising:
a measuring unit configured to measure the penetration depth of the molten pool by interferometry; and
a controller configured to control the measuring unit,
wherein the measuring unit includes
a light source configured to emit a laser beam for measurement,
a splitter configured to split the laser beam for measurement into a measuring beam travelling toward the molten pool and a reference beam travelling toward a reference mirror,
a light-receiving element configured such that an interference beam is incident on the light-receiving element, the interference beam being synthesized from the measuring beam reflected from the molten pool and the reference beam reflected from the reference mirror,
a scanning mechanism configured to vary an application position of the measuring beam travelling toward the molten pool, and
an image-capturing unit configured to capture an image of the molten pool, and wherein the controller is configured to
i) determine a deepest portion of the molten pool based on a result of image capturing performed by the image-capturing unit, and
ii) control the scanning mechanism such that the measuring beam travelling toward the molten pool is applied to the deepest portion.

2. A laser welding apparatus comprising:
a laser welding unit including
a first light source configured to emit a laser beam for welding, and
a first scanning mechanism configured to vary an application position of the laser beam for welding;
a measuring unit configured to measure a penetration depth of a molten pool of a workpiece during laser welding by interferometry; and
a controller configured to control the laser welding unit and the measuring unit,
wherein the measuring unit includes
a second light source configured to emit a laser beam for measurement,
a splitter configured to split the laser beam for measurement into a measuring beam travelling toward the molten pool and a reference beam travelling toward a reference mirror,
a light-receiving element configured such that an interference beam is incident on the light-receiving element, the interference beam being synthesized from the measuring beam reflected from the molten pool and the reference beam reflected from the reference mirror,
a second scanning mechanism configured to vary an application position of the measuring beam travelling toward the molten pool, and
an image-capturing unit configured to capture an image of the molten pool, and wherein the controller is configured to
i) determine a deepest portion of the molten pool based on a result of image capturing performed by the image-capturing unit,
ii) control the second scanning mechanism such that the measuring beam travelling toward the molten pool is applied to the deepest portion, and measure a penetration depth of the deepest portion, and
iii) control a power of the first light source based on the penetration depth of the deepest portion.
